(19) United States
(12) Patent Application Publication
(10) Pub. No.: US 2026/0195855 A1
(43) Pub. Date: Jul. 9, 2026

(54) METHOD FOR IMAGE RESOLUTION ADJUSTMENT AND APPARATUS, DEVICE AND STORAGE MEDIUM

(71) Applicant: BOE Technology Group Co., Ltd., Beijing (CN)

(72) Inventors: Dan ZHU, Beijing (CN); Mengdi SUN, Beijing (CN)

(21) Appl. No.: 19/132,918

(22) PCT Filed: Sep. 27, 2023
(86) PCT No.: PCT/CN2023/122051

§ 371 Date: May 27, 2025

(30) Foreign Application Priority Data
Nov. 30, 2022 (CN) 202211530106.3

(51) Int. Cl. G06T 3/4053; G06T 7/11; G06T 7/13; G06V 10/40

(52) U.S. Cl. CPC G06T 3/4053; G06T 7/11; G06T 7/13; G06V 10/40

(57) ABSTRACT

A method for image resolution adjustment, device, apparatus, and storage medium. The method includes: acquiring an image to be adjusted and a first target resolution, resolution of the image to be adjusted being higher than the first target resolution; partitioning the image to be adjusted into N candidate images having resolution equal to the first target resolution, wherein data of each pixel in the image to be adjusted is included in any of the candidate images, N is a positive integer greater than 1; extracting edge feature data from the candidate images obtained by partitioning; and synthesizing the N candidate images obtained by partitioning and the extracted edge feature data to obtain a target image having resolution equal to the first target resolution.

The present application is a national stage of PCT application No. PCT/CN2023/122051, filed on Sep. 27, 2023, which claims priority to Chinese Patent Application No. 202211530106.3, filed on Nov. 30, 2022 and entitled “METHOD FOR IMAGE RESOLUTION ADJUSTMENT AND APPARATUS, DEVICE AND STORAGE MEDIUM”, the entire contents of both of which are incorporated herein by reference.

### TECHNICAL FIELD

The present invention relates to the field of image processing technology, and in particular to a method for image resolution adjustment, device, apparatus, and storage medium.

### BACKGROUND ART

In practical image processing applications, adjusting the resolution of images is often required. For instance, images of fixed dimensions may need resolution adjustments to adapt to display screens of varying sizes, either by lowering or increasing resolution.

In related arts, resolution of an image can be reduced by directly deleting a subset of pixels in the image, and resolution of the image can be increased by replicating a subset of pixels in the image.

For example, when reducing the resolution of an image, odd rows or odd columns of pixels can be directly deleted; when increasing the resolution of an image, odd rows or odd columns of pixels can be directly replicated.

However, using these methods to adjust the resolution of images often results in poor display effects after the adjustment.

For example, when reducing the image resolution, directly deleting a subset of pixels causes partial information loss, resulting reduced clarity and suboptimal visual presentation of the adjusted image; when increasing the image resolution, directly replicating partial pixels and inserting them into the image induces distortion, leading to degraded display fidelity.

### SUMMARY OF THE INVENTION

The invention provides a method for image resolution adjustment, device, apparatus and storage medium.

According to the first aspect of the invention, a method for image resolution adjustment is provided, the method including: acquiring an image to be adjusted and a first target resolution, resolution of the image to be adjusted being higher than the first target resolution; partitioning the image to be adjusted into N candidate images having resolution equal to the first target resolution, wherein data of each pixel in the image to be adjusted is included in any of the candidate images, N is a positive integer greater than 1; extracting edge feature data from the candidate images obtained by partitioning; and synthesizing the N candidate images obtained by partitioning and the extracted edge feature data to obtain a target image having resolution equal to the first target resolution.

Optionally, partitioning the image to be adjusted into N candidate images having resolution equal to the first target resolution includes: partitioning the image to be adjusted into a quantity of pixel matrices having the same size based on the first target resolution, wherein each of the pixel matrices includes N pixels; wherein in the image to be adjusted, the quantity of pixel matrices in a single row by partitioning in a horizontal direction is the same as the quantity of pixels in a single row of the first target resolution, and the quantity of pixel matrices in a single column by partitioning in a vertical direction is the same as the quantity of pixels in a single column of the first target resolution; and, extracting N candidate images having resolution equal to the first target resolution based on the partitioned pixel matrices.

Optionally, pixels at the same position in different candidate images belong to the same pixel matrix, and different pixels in any candidate image are located at the same position in pixel matrices to which they belong.

Optionally, extracting edge feature data from the candidate images obtained by partitioning, includes: determining any one of the candidate images as a starting image; and for the starting image, by using N−1 preset convolution kernels corresponding to N−1 other candidate images, extracting N−1 edge feature images corresponding to the N−1 other candidate images, wherein resolution of the edge feature images is equal to the first target resolution; wherein different candidate images correspond to different preset convolution kernels, the preset convolution kernels are configured to extract inter-pixel gradient feature data in a preset direction, the preset direction is a relative direction between two different pixels at the same position in a corresponding candidate image and the starting image and belong to the same pixel matrix.

Optionally, synthesizing the N candidate images obtained by partitioning and the extracted edge feature data to obtain a target image having resolution equal to the first target resolution, includes: inputting the N candidate images obtained by partitioning and the extracted N−1 edge feature images into a pre-trained image channel fusing network to obtain a target image having resolution equal to the first target resolution and output by the image channel fusing network.

Optionally, the image channel fusing network is configured to: for each of the N−1 other candidate images, perform channel concatenation with a corresponding edge feature image to obtain N−1 concatenated images; for the N−1 concatenated images and the starting image, use a feature extraction layer to extract features to obtain N convolutional feature images; and perform channel concatenation on the N convolutional feature images, and extracting features using a channel fusing layer to obtain a target image having resolution equal to the first target resolution and having the same quantity of channels as the image to be adjusted.

Optionally, extracting edge feature data from the candidate images obtained by partitioning, includes: for each identical position among the N candidate images obtained by partitioning, performing the following operations to obtain a max pooling feature map having the first target resolution, and determining the max pooling feature map as the extracted edge feature data: for each target position, determining a maximum pixel value among pixel values of N corresponding pixels at the target position in the N candidate images as a pixel value of a pixel at the target position in the max pooling feature map.

Optionally, synthesizing the N candidate images obtained by partitioning and the extracted edge feature data to obtain a target image having resolution equal to the first target resolution, includes: inputting the N candidate images obtained by the partitioning and the max pooling feature map into a pre-trained image channel fusing network to obtain a target image having the first target resolution and output by the image channel fusing network.

Optionally, the image channel fusing network is configured to: for each of the N candidate images, perform channel concatenation with the max pooling feature map, to obtain N concatenated results; for each of the N concatenated results, use the feature extraction layer to extract features to obtain N alternative images having resolution equal to the first target resolution and the same quantity of channels as the image to be adjusted; and input the N alternative images into the max pooling layer to obtain a target image having resolution equal to the first target resolution and the same quantity of channels as the image to be adjusted.

Optionally, the max pooling layer is configured to: for each identical position among the N alternative images, perform the following operations to obtain a target image having resolution equal to the first target resolution and the same quantity of channels as the image to be adjusted: among the N alternative images, determining the pixel value corresponding to the pixel at the target position in the target image as the pixel value corresponding to the pixel at the target position in the image to be adjusted.

According to a second aspect of the invention, another method for image resolution adjustment is provided, the method including: acquiring an image to be adjusted and a second target resolution, resolution of the image to be adjusted being lower than the second target resolution; determining M pixel expansion directions based on the second target resolution and the resolution of the image to be adjusted, wherein M is a positive integer and M≤1, and a product of (M+1) and the resolution of the image to be adjusted is greater than or equal to the second target resolution; acquiring M edge feature data in the M pixel expansion directions for the image to be adjusted, respectively; and synthesizing the image to be adjusted and the M edge feature data to obtain a target image having resolution equal to the second target resolution.

Optionally, acquiring M edge feature data in the M pixel expansion directions for the image to be adjusted, respectively, includes: for the image to be adjusted, by using M preset convolution kernels corresponding to the M pixel expansion directions, extracting M edge feature images, wherein resolution of the edge feature images is the same as the resolution of the image to be adjusted; wherein different pixel expansion directions correspond to different preset convolution kernels, and each of the preset convolution kernels is configured to extract inter-pixel gradient feature data in a corresponding pixel expansion direction.

Optionally, synthesizing the image to be adjusted and the M edge feature data to obtain a target image having resolution equal to the second target resolution, includes: inputting the image to be adjusted and the M edge feature images into a pre-trained image composition network to obtain a target image having resolution equal to the second target resolution and output by the image composition network, wherein the target image has the same quantity of channels as the image to be adjusted.

Optionally, the image composition network is configured to: for the M edge feature images, perform channel concatenation with the image to be adjusted to obtain M concatenated results; for the M concatenated results and the image to be adjusted, use the feature extraction layer to extract features to obtain M+1 images to be composited and having the same resolution and quantity of channels as the image to be adjusted; and input the M+1 images to be composited into the composition layer to obtain a target image having resolution equal to the second target resolution and the same quantity of channels as the image to be adjusted.

Optionally, the composition layer is configured to: perform following operations on each pixel in the image to be composited with and corresponding to the image to be adjusted, to obtain a composition result: starting from a target pixel, generating, by expanding along M pixel expansion directions, a pixel matrix having M+1 pixels, and integrating pixels at the same positions as the target pixel in M other images to be composited into the pixel matrix obtained by expanding; and based on the composition result obtained, performing a predetermined image processing to obtain a target image having resolution equal to the second target resolution and the same quantity of channels as the image to be adjusted.

According to the third aspect of the invention, an image resolution adjustment device is provided, the device including: a first acquisition unit configured for acquiring an image to be adjusted and a first target resolution, resolution of the image to be adjusted being higher than the first target resolution; a partitioning unit configured for partitioning the image to be adjusted into N candidate images having resolution equal to the first target resolution, wherein data of each pixel in the image to be adjusted is included in any of the candidate images, N is a positive integer greater than 1; a first feature unit configured for extracting edge feature data from the candidate images obtained by partitioning; and a first synthesizing unit configured for synthesizing the N candidate images obtained by partitioning and the extracted edge feature data to obtain a target image having resolution equal to the first target resolution.

Optionally, the partitioning unit is configured for: partitioning the image to be adjusted into a quantity of pixel matrices having the same size based on the first target resolution, wherein each of the pixel matrices includes N pixels; wherein in the image to be adjusted, the quantity of pixel matrices in a single row by partitioning in a horizontal direction is the same as the quantity of pixels in a single row of the first target resolution, and the quantity of pixel matrices in a single column by partitioning in a vertical direction is the same as the quantity of pixels in a single column of the first target resolution; and, extracting N candidate images having resolution equal to the first target resolution based on the partitioned pixel matrices.

Optionally, pixels at the same position in different candidate images belong to the same pixel matrix, and different pixels in any candidate image are located at the same position in pixel matrices to which they belong.

Optionally, the first feature unit is configured for: determining any one of the candidate images as a starting image; and for the starting image, by using N−1 preset convolution kernels corresponding to N−1 other candidate images, extracting N−1 edge feature images corresponding to the N−1 other candidate images, wherein resolution of the edge feature images is equal to the first target resolution; wherein different candidate images correspond to different preset convolution kernels, the preset convolution kernels are configured to extract inter-pixel gradient feature data in a preset direction, the preset direction is a relative direction between two different pixels at the same position in a corresponding candidate image and the starting image and belong to the same pixel matrix.

Optionally, the first synthesizing unit is configured for: inputting the N candidate images obtained by partitioning and the extracted N−1 edge feature images into a pre-trained image channel fusing network to obtain a target image having resolution equal to the first target resolution and output by the image channel fusing network.

Optionally, the image channel fusing network is configured to: for each of the N−1 other candidate images, perform channel concatenation with a corresponding edge feature image to obtain N−1 concatenated images; for the N−1 concatenated images and the starting image, use a feature extraction layer to extract features to obtain N convolutional feature images; and perform channel concatenation on the N convolutional feature images, and extracting features using a channel fusing layer to obtain a target image having resolution equal to the first target resolution and having the same quantity of channels as the image to be adjusted.

Optionally, the first feature unit is configured for: for each identical position among the N candidate images obtained by partitioning, performing the following operations to obtain a max pooling feature map having the first target resolution, and determining the max pooling feature map as the extracted edge feature data: for each target position, determining a maximum pixel value among pixel values of N corresponding pixels at the target position in the N candidate images as a pixel value of a pixel at the target position in the max pooling feature map.

Optionally, the first synthesizing unit is configured for: inputting the N candidate images obtained by the partitioning and the max pooling feature map into a pre-trained image channel fusing network to obtain a target image having the first target resolution and output by the image channel fusing network.

Optionally, the image channel fusing network is configured to: for each of the N candidate images, perform channel concatenation with the max pooling feature map, to obtain N concatenated results; for each of the N concatenated results, use the feature extraction layer to extract features to obtain N alternative images having resolution equal to the first target resolution and the same quantity of channels as the image to be adjusted; and input the N alternative images into the max pooling layer to obtain a target image having resolution equal to the first target resolution and the same quantity of channels as the image to be adjusted.

Optionally, the max pooling layer is configured to: for each identical position among the N alternative images, perform the following operations to obtain a target image having resolution equal to the first target resolution and the same quantity of channels as the image to be adjusted: among the N alternative images, determining the pixel value corresponding to the pixel at the target position in the image to be adjusted as the pixel value corresponding to the pixel at the target position in the target image.

According to the fourth aspect of the invention, another image resolution adjustment device is provided, the device including: a second acquisition unit configured for acquiring an image to be adjusted and a second target resolution, resolution of the image to be adjusted being lower than the second target resolution; a direction determination unit configured for determining M pixel expansion directions based on the second target resolution and the resolution of the image to be adjusted, wherein M is a positive integer and M≥1, and a product of (M+1) and the resolution of the image to be adjusted is greater than or equal to the second target resolution; a second feature unit configured for acquiring M edge feature data in the M pixel expansion directions for the image to be adjusted, respectively; and a second synthesizing unit configured for synthesizing the image to be adjusted and the M edge feature data to obtain a target image having resolution equal to the second target resolution.

Optionally, the second feature unit is configured for: for the image to be adjusted, by using M preset convolution kernels corresponding to the M pixel expansion directions, extracting M edge feature images, wherein resolution of the edge feature images is the same as the resolution of the image to be adjusted; wherein different pixel expansion directions correspond to different preset convolution kernels, and each of the preset convolution kernels is configured to extract inter-pixel gradient feature data in a corresponding pixel expansion direction.

Optionally, the second synthesizing unit is configured for: inputting the image to be adjusted and the M edge feature images into a pre-trained image composition network to obtain a target image having resolution equal to the second target resolution and output by the image composition network, wherein the target image has the same quantity of channels as the image to be adjusted.

Optionally, the image composition network is configured to: for the M edge feature images, perform channel concatenation with the image to be adjusted to obtain M concatenated results; for the M concatenated results and the image to be adjusted, use the feature extraction layer to extract features to obtain M+1 images to be composited and having the same resolution and quantity of channels as the image to be adjusted; and input the M+1 images to be composited into the composition layer to obtain a target image having resolution equal to the second target resolution and the same quantity of channels as the image to be adjusted.

Optionally, the composition layer is configured to: perform following operations on each pixel in the image to be composited with and corresponding to the image to be adjusted, to obtain a composition result: starting from a target pixel, generating, by expanding along M pixel expansion directions, a pixel matrix having M+1 pixels, and integrating pixels at the same positions as the target pixel in M other images to be composited into the pixel matrix obtained by expanding; and based on the composition result obtained, performing a predetermined image processing to obtain a target image having resolution equal to the second target resolution and the same quantity of channels as the image to be adjusted.

It should be understood that the above general description and the detailed description below are merely exemplary and explanatory, and do not limit the scope of the present invention.

### BRIEF DESCRIPTION OF THE DRAWINGS

The figures herein are incorporated into the specification and form part of the specification, illustrating embodiments of the present invention and, together with the specification, explaining the principles of the present invention.

FIG. 1 is a flowchart showing a method for image resolution adjustment according to an embodiment of the present invention;

FIG. 2 is a flowchart showing another method for image resolution adjustment according to an embodiment of the present invention;

FIG. 3 is a structural diagram showing an image downsampling network according to an embodiment of the present invention;

FIG. 4 is a structural diagram of another image subsampling network according to an embodiment of the present invention;

FIG. 5 is a structural diagram of an image super-resolution network according to an embodiment of the present invention;

FIG. 6 is a structural diagram of an image resolution adjustment device according to an embodiment of the present invention;

FIG. 7 is a schematic diagram of another image resolution adjustment device according to an embodiment of the present invention; and

FIG. 8 is a schematic diagram of a computer apparatus hardware configuration for configuring the method according to an embodiment of the present invention.

### DETAILED DESCRIPTION

Here, exemplary embodiments will be described in detail, and examples are shown in the accompanying drawings. When the following description refers to the accompanying drawings, unless otherwise indicated, the same marking in different drawings indicates the same or similar elements. The embodiments described in the following exemplary embodiments do not represent all embodiments consistent with the present invention. Rather, they are merely examples of devices and methods consistent with some aspects of the present invention as detailed in the accompanying claims.

In practical image processing applications, adjusting the resolution of images is often required. For instance, images of fixed dimensions may need resolution adjustments to adapt to display screens of varying sizes, either by lowering or increasing resolution.

In related arts, resolution of an image can be reduced by directly deleting a subset of pixels in the image, and resolution of the image can be increased by replicating a subset of pixels in the image.

For example, when reducing the resolution of an image, odd rows or odd columns of pixels can be directly deleted; when increasing the resolution of an image, odd rows or odd columns of pixels can be directly replicated.

However, using these methods to adjust the resolution of images often results in poor display effects after the adjustment.

For example, when reducing the image resolution, directly deleting a subset of pixels causes partial information loss, resulting reduced clarity and suboptimal visual presentation of the adjusted image; when increasing the image resolution, directly replicating partial pixels and inserting them into the image induces distortion, leading to degraded display fidelity.

In order to improve the display effect of an image after adjusting its resolution, the embodiment of the present invention provides a method for image resolution adjustment.

In this method, edge feature data can be extracted from the image to be adjusted for use in adjusting the image resolution. Specifically, the resolution can be increased or decreased.

In order to meet the need for resolution reduction, this method retains all pixels in the image to be adjusted for use in reducing the resolution, thereby reducing the loss of information in the image to be adjusted and improving the display effect.

In order to meet the need for increasing the resolution, in this method, edge feature data in each expandable direction of the image to be adjusted can be configured to help expand pixels, thereby increasing the resolution, reducing image distortion, and improving the display effect.

Therefore, in this method, edge feature data can be introduced for image resolution adjustment during the image resolution adjustment process, thereby improving the display effect. Compared with the method for image resolution adjustment of simply and roughly deleting and copying pixels, the display effect can be improved.

The following is a detailed explanation of a method for image resolution adjustment provided by the embodiment of the present invention.

The embodiment of the present invention provides an embodiment of a method for reducing image resolution.

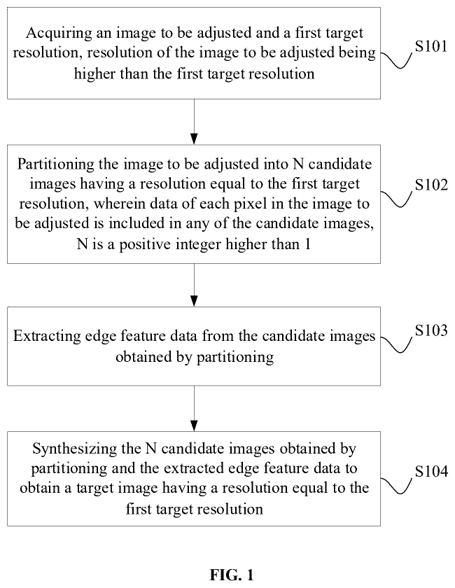

As shown in FIG. 1, FIG. 1 is a flowchart illustrating a method for image resolution adjustment according to an embodiment of the present invention.

The embodiment of the present invention imposes no restrictions the execution entity of the method. Optionally, the execution entity can be any computing apparatus. For example, a server, a display terminal, a personal computer, a camera, etc.

The method may include the following steps.

In S101, an image to be adjusted and a first target resolution are acquired, resolution of the image to be adjusted being higher than the first target resolution.

In S102, the image to be adjusted is partitioned into N candidate images having resolution equal to the first target resolution, wherein data of each pixel in the image to be adjusted is included in any of the candidate images, N is a positive integer greater than 1.

In S103, edge feature data is extracted from the candidate images obtained by partitioning.

In S104, the N candidate images obtained by partitioning and the extracted edge feature data are synthesized to obtain a target image having resolution equal to the first target resolution.

The above method can improve the display effect by introducing edge feature data for image resolution adjustment during the image resolution adjustment process.

In addition, in the process of reducing the resolution, the above method can conveniently perform feature extraction directly based on multiple candidate images by partitioning the image to be adjusted into multiple candidate images having the first target resolution, which can be a feature extraction method that does not change the image resolution.

Furthermore, in the above method, by limiting each pixel in the image to be adjusted to be included in any candidate image, all pixels in the image to be adjusted can be used for resolution adjustment, thereby reducing the loss of data in the image to be adjusted and improving the display effect.

Optionally, the above method can be performed by a pre-trained image downsampling network. See the explanation below for details.

The following is a detailed explanation of each step.

First, in S101, the image to be adjusted and the first target resolution are acquired, the resolution of the image to be adjusted being higher than the first target resolution.

This method imposes no restrictions the form of the image to be adjusted. Specifically, the quantity of channels of the image to be adjusted is not limited.

Optionally, the image to be adjusted can include images with three RGB channels, or feature images with multiple channels.

Optionally, the image to be adjusted can include feature images obtained by feature extraction based on the original image. The feature extraction method is not limited, nor is the quantity of channels of the image to be adjusted.

Optionally, the first target resolution can be the target resolution that needs to be adjusted for the image to be adjusted.

Second, in S102, the image to be adjusted is partitioned into N candidate images having resolution equal to the first target resolution, wherein data of each pixel in the image to be adjusted is included in any of the candidate images, N is a positive integer greater than 1.

The method imposes no restrictions on the approach employed to determine N.

Optionally, the product of N and the first target resolution can be higher than or equal to the resolution of the image to be adjusted.

This method imposes no restrictions the method of division.

Optionally, in order to ensure the integrity of the candidate images, a portion of the pixels can be selected from the image to be adjusted and composited into candidate images; or the image to be adjusted can be partitioned into different parts.

Optionally, when the image to be adjusted is partitioned into multiple different parts, composition and splicing can be performed during subsequent synthesis to obtain the target image.

Optionally, overlapping parts between different candidate images obtained by division are allowed. Among them, since the resolution of the image to be adjusted may not be an integer multiple of the first target resolution, it is not possible to directly partition N non-overlapping candidate images.

In an optional embodiment, multiple pixel matrices can be partitioned first, and then a pixel composition can be selected from each pixel matrix to form a candidate image.

Optionally, the image to be adjusted can be partitioned into N candidate images having the first target resolution, which can include: partitioning the image to be adjusted into a quantity of pixel matrices having the same size based on the first target resolution; the pixel matrix can include N pixels; extracting N candidate images having the first target resolution according to the partitioned pixel matrix.

Optionally, in the image to be adjusted, the quantity of pixel matrices in a single row by partitioning in a horizontal direction can be the same as the quantity of single-row pixels of the first target resolution, and the quantity of pixel matrices in a single column by partitioning in a vertical direction can be the same as the quantity of single-column pixels of the first target resolution. The subsequent steps can synthesize a pixel for each pixel matrix to obtain a target image having resolution equal to the first target resolution.

Optionally, based on the partitioned pixel matrices, N candidate images having the first target resolution can be extracted, which can include: extracting one pixel from each of the partitioned pixel matrices; and compositing the extracted pixels into a candidate image according to the relative positional relationship between the pixel matrices to which they belong.

Optionally, different pixel points can be extracted from the same pixel matrix between different candidate images, thereby obtaining N candidate images.

Optionally, for a single candidate image, pixel points can be extracted from the same position in each pixel matrix and composited to form a candidate image. Optionally, pixels can be extracted from different positions in different pixel matrices and composited into candidate images.

Optionally, pixels at the same position in different candidate images can belong to the same pixel matrix; different pixels in any candidate image can be located at the same position in the pixel matrix to which they belong.

Optionally, overlapping parts are allowed between the partitioned pixel matrices.

In this embodiment, by partitioning the pixel matrix, it is easy to partition candidate images with high overall integrity, which facilitates the subsequent extraction of edge feature data.

For ease of understanding, in a specific example, for an image to be adjusted having resolution of 16*16, the first target resolution can be 8*8. Thus, 64 non-overlapping 2*2 pixel matrices can be partitioned for the image to be adjusted, facilitating the extraction of four candidate images having resolution of 8*8.

Third, in S103, Extract edge feature data from the candidate images obtained by partitioning. In S104, Synthesize the N candidate images obtained by partitioning and the extracted edge feature data to obtain a target image having the first target resolution.

Since the extracted edge feature data is related to the subsequent synthesis method, S103 and S104 are explained together.

This method imposes no restrictions the specific method of extracting edge feature data.

Optionally, edge feature data can be extracted separately for each candidate image; edge feature data can also be extracted separately for some candidate images; or all candidate images can be synthesized and edge feature data can be extracted using pooling, which can be max pooling, average pooling, or minimum pooling.

This method imposes no restrictions the specific synthesis method.

Optionally, a pre-trained network or model can be configured to input N candidate images and the extracted edge feature data to obtain a target image having resolution equal to the first target resolution output by the network or model. Alternatively, the N candidate images and the extracted edge feature data can be directly channel-concatenated, and the channels can be merged based on the concatenation results to obtain a target image having resolution equal to the first target resolution.

For ease of understanding, two optional embodiments are provided below for illustrative purposes.

### Example 1

In this embodiment, the image to be adjusted is partitioned into N candidate images having the first target resolution, which may include: partitioning the image to be adjusted into a quantity of pixel matrices having the same size based on the first target resolution; the pixel matrix may include N pixels; extracting N candidate images having the first target resolution according to the partitioned pixel matrix.

Among them, in the image to be adjusted, the quantity of pixel matrices in a single row by partitioning in a horizontal direction can be the same as the quantity of single-row pixels of the first target resolution, and the quantity of pixel matrices in a single column by partitioning in a vertical direction can be the same as the quantity of single-column pixels of the first target resolution.

Pixel points at the same position in different candidate images can belong to the same pixel matrix; different pixel points in any candidate image can be located at the same position in the pixel matrix to which they belong.

Furthermore, in this embodiment, any candidate image can be determined as the starting image, so that the same pixel matrix to which two pixels at the same position belong can be determined between any other candidate image and the starting image, and the fixed relative direction between these two pixels can be determined in the same pixel matrix to which they belong.

Based on this relative direction, the inter-pixel gradient feature data of the starting image in the relative direction can be acquired to characterize the edge feature data. Furthermore, the extracted inter-pixel gradient feature data and the corresponding other candidate images can be configured to characterize the change features between pixels in the image to be adjusted, thereby facilitating feature extraction for resolution adjustment and improving the display effect.

Optionally, for the candidate images obtained by partitioning, the edge feature data can be extracted, which can include: determining any candidate image as the starting image; for the starting image, using N−1 preset convolution kernels corresponding to N−1 other candidate images to extract N−1 edge feature images corresponding to N−1 other candidate images; the resolution of the edge feature images can be the first target resolution.

Optionally, different candidate images can correspond to different preset convolution kernels; the preset convolution kernels can be configured to extract inter-pixel gradient feature data in the preset direction; the preset direction can include the relative direction in the same pixel matrix of different pixels at the same position between the corresponding candidate image and the starting image.

Specific examples of preset convolution kernels can be found below.

This embodiment imposes no restrictions the synthesis method.

Optionally, the N candidate images obtained by partitioning and the N−1 edge feature images extracted can be channel-concatenated, and then features can be extracted to obtain the target image.

Optionally, the N−1 other candidate images can be channel-concatenated with the corresponding N−1 edge feature images to obtain N−1 concatenated results, and then features can be extracted from the N−1 concatenated results and the starting image, and the extracted N features can be synthesized to obtain the target image.

Optionally, a pre-trained model or network can be configured to extract features from the N candidate images and the N−1 extracted edge feature images to obtain the target image.

Optionally, the N candidate images obtained by partitioning and synthesizing can be composited with the extracted edge feature data to obtain a target image having resolution equal to the first target resolution. This can include: inputting the N candidate images obtained by partitioning and the N−1 edge feature images extracted into a pre-trained image channel fusing network to obtain a target image having resolution equal to the first target resolution output by the image channel fusing network.

Optionally, the quantity of channels of the target image and the image to be adjusted can be the same.

This embodiment imposes no restrictions the specific structure of the image channel fusing network.

Optionally, the image channel fusing network can include only a convolution layer, or it can include a convolution layer and an output layer for outputting the target image.

Optionally, the image channel fusing network may include a feature extraction layer and a channel fusing layer. Among them, the feature extraction layer can be configured to extract image features and may specifically include one or more convolution layers. The channel fusing layer can be configured to extract image features, merge image channels, and reduce the quantity of image channels.

Optionally, the image channel fusing network can be used for: for N−1 other candidate images, perform channel concatenation with the corresponding edge feature images to obtain N−1 concatenated images; for the N−1 concatenated images and the starting image, use the feature extraction layer to extract features to obtain N convolutional feature images; perform channel concatenation on the N convolutional feature images, and then use the channel fusing layer to extract features to obtain a target image having resolution equal to the first target resolution and the same quantity of channels as the image to be adjusted.

Optionally, the image channel fusing network can also be used for: for N candidate images and N−1 edge feature images, use the feature extraction layer to extract features to obtain 2N−1 convolutional feature images; perform channel concatenation on the 2N−1 convolutional feature images, and then use the channel fusing layer to extract features to obtain a target image having resolution equal to the first target resolution and the same quantity of channels as the image to be adjusted.

This embodiment imposes no restrictions the structure and function of the feature extraction layer and the channel fusing layer.

Optionally, the feature extraction layer may include multiple different convolution layers, specifically include N different convolution layers. Thus, for N−1 concatenated images and the starting image, features can be extracted using different convolution layers in the feature extraction layer to obtain N convolutional feature images.

Among them, optionally, the quantity of channels of the N−1 concatenated images is usually higher than that of the starting image, so the convolution layer corresponding to the N−1 concatenated images can be configured to merge image channels, thereby reducing the quantity of image channels. Optionally, the quantity of channels between the N convolutional feature images can be the same.

Through different convolutional layers, image features of different branches can be learned separately, thereby facilitating the improvement of the image channel fusing network and improving the display effect.

Optionally, the channel fusing layer may include one or more series of convolutional layers, so that the image channels can be merged by extracting features, thereby reducing the quantity of image channels.

### Example 2

In this embodiment, the image to be adjusted is partitioned into N candidate images having resolution equal to the first target resolution, which may include: partitioning the image to be adjusted into a quantity of pixel matrices having the same size based on the first target resolution; the pixel matrix may include N pixels; extracting N candidate images having resolution equal to the first target resolution according to the partitioned pixel matrix.

Among them, in the image to be adjusted, the quantity of pixel matrices in a single row by partitioning in a horizontal direction can be the same as the quantity of single-row pixels of the first target resolution, and the quantity of pixel matrices in a single column by partitioning in a vertical direction can be the same as the quantity of single-column pixels of the first target resolution.

Optionally, pixels at the same position in different candidate images can belong to the same pixel matrix; different pixels in any candidate image can be located at the same position in the pixel matrix to which they belong.

Optionally, different pixels in any candidate image can also be located at different positions in the pixel matrix to which they belong. Different pixels in a single candidate image can be located at different positions in the pixel matrix to which they belong.

Furthermore, in this embodiment, the max pooling method can be configured to extract the edge feature data of the image, which facilitates the extraction of texture detail information in the image, thereby facilitating the extraction of features, which can be configured to adjust the resolution and improve the display effect.

Optionally, for the candidate images obtained by partitioning, the extraction of edge feature data can include: for each same position among the N candidate images obtained by partitioning, performing the following operations obtain the max pooling feature map having the first target resolution, and determine the max pooling feature map as the extracted edge feature data: among the N candidate images, determine the pixel value corresponding to the N pixel points at the corresponding positions as the pixel value corresponding to the pixel point at the corresponding position in the max pooling feature map.

This embodiment imposes no restrictions the synthesis method.

Optionally, the N candidate images obtained by partitioning and the max pooling feature map can be channel-concatenated, and then features can be extracted to obtain the target image.

Optionally, the N candidate images can be channel-concatenated with the max pooling feature map to obtain N concatenated results, and then features can be extracted from the N concatenated results, and the extracted N features can be synthesized to obtain the target image.

Optionally, a pre-trained model or network can be configured to extract features from the N candidate images and the max pooling feature map to obtain the target image.

Optionally, the N candidate images obtained by partitioning and synthesizing and the extracted edge feature data can be configured to obtain a target image having resolution equal to the first target resolution. This can include: inputting the N candidate images obtained by partitioning and the max pooling feature map into a pre-trained image channel fusing network to obtain a target image having resolution equal to the first target resolution and output by the image channel fusing network.

Optionally, the target image can have the same quantity of channels as the image to be adjusted.

This embodiment imposes no restrictions the specific structure of the image channel fusing network.

Optionally, the image channel fusing network can include only a convolution layer, or it can include a convolution layer and an output layer for outputting the target image.

Optionally, the image channel fusing network may include a feature extraction layer and a max pooling layer. Among them, the feature extraction layer can be configured to extract image features and may specifically include one or more convolution layers. The max pooling layer can be configured to synthesize multiple images output by the feature extraction layer through max pooling to obtain the target image.

Optionally, the image channel fusing network can be used for: For N candidate images, perform channel concatenation with the max pooling feature map to obtain N concatenated results; for the N concatenated results, use the feature extraction layer to extract features to obtain N alternative images having resolution equal to the first target resolution and the same quantity of channels as the image to be adjusted; input the N alternative images into the max pooling layer to obtain a target image having resolution equal to the first target resolution and the same quantity of channels as the image to be adjusted.

Optionally, the image channel fusing network can also be used for: For N candidate images and the max pooling feature map, use the feature extraction layer to extract features to obtain N+1 candidate images having the first target resolution and the same quantity of channels as the image to be adjusted; input the N+1 candidate images into the max pooling layer to obtain the target image having the first target resolution and the same quantity of channels as the image to be adjusted.

This embodiment imposes no restrictions the structure and function of the feature extraction layer and the max pooling layer.

Optionally, the feature extraction layer may include multiple different convolution layers, specifically include N different convolution layers. Thus, for N concatenated results, different convolution layers in the feature extraction layer can be configured to extract features to obtain N alternative images. Specifically, a feature extraction method that does not change the image resolution can be used.

Optionally, the feature extraction layer can merge channels separately for the N concatenated results to reduce the quantity of image channels.

Through different convolution layers, image features of different branches can be learned separately, thereby facilitating the improvement of the image channel fusing network and improving the display effect.

Optionally, the max pooling layer can be configured to perform the following operation on each identical position among the N candidate images to obtain the target image having the first target resolution: among the N candidate images, determine the pixel value corresponding to the pixel at the target position in the target image as the pixel value corresponding to the N pixels at the target position.

In another optional embodiment, the target images obtained in the first and second embodiments above can be synthesized to obtain the final target image.

In an optional embodiment, the embodiment included in the above method can be implemented with a single image downsampling network.

The image downsampling network can be configured to downsample the image to be adjusted, thereby reducing the resolution.

Optionally, the image to be adjusted and the first target resolution can be input to the image downsampling network to acquire the target image output by the image downsampling network.

Optionally, the image downsampling network may include the image channel fusing network and/or the image channel fusing network in the above-mentioned embodiment. The image downsampling network may further perform the method of the above-mentioned embodiment 1 and/or embodiment 2 on the N candidate images obtained by partitioning the image to be adjusted to obtain the target image.

The above process of method explains an embodiment of reducing the resolution.

The present invention also provides an embodiment of a method for improving image resolution.

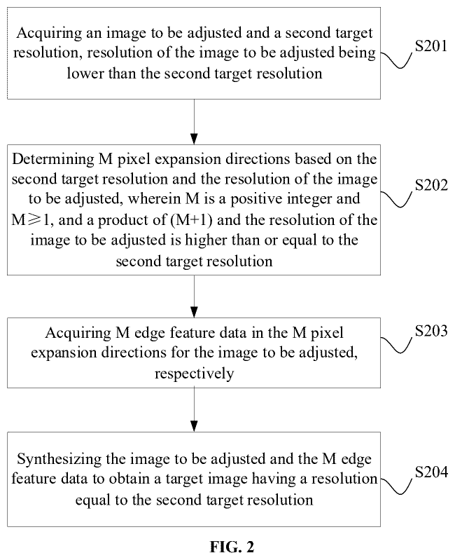

As shown in FIG. 2, FIG. 2 is a flowchart illustrating another method for image resolution adjustment according to an embodiment of the present invention.

The embodiments of the present invention do not limit the execution entity of the method. Optionally, the execution entity can be any computing apparatus. For example, a server, a display terminal, a personal computer, a camera, etc.

The method may include the following steps.

In S201, Acquiring the image to be adjusted and the second target resolution, resolution of the image to be adjusted being lower than the second target resolution.

In S202, Determine M pixel expansion directions based on the second target resolution and the resolution of the image to be adjusted.

Optionally, M can be a positive integer and M≥1; wherein the product of (M+1) and the resolution of the image to be adjusted can be greater than or equal to the second target resolution.

In S203, For the image to be adjusted, acquire M edge feature data in M pixel expansion directions.

In S204, Synthesize the image to be adjusted and the M edge feature data to obtain a target image having resolution equal to the second target resolution.

The above method can improve the display effect by introducing edge feature data for image resolution adjustment during the image resolution adjustment process.

In addition, the above method can determine multiple pixel expansion directions during the resolution improvement process and determine the edge feature data in each pixel expansion direction, which facilitates subsequent feature extraction and improves the display effect.

Optionally, the above method can be performed by a pre-trained image super-resolution network. See the explanation below for details.

The following is a detailed explanation of each step.

First, in S201, Acquire the image to be adjusted and the second target resolution, resolution of the image to be adjusted being lower than the second target resolution.

This method imposes no restrictions the form of the image to be adjusted. Specifically, the quantity of channels of the image to be adjusted is not limited.

Optionally, the image to be adjusted can include an image with three RGB channels, or it can include a feature image with multiple channels.

Optionally, the image to be adjusted can include a feature image obtained by feature extraction based on the original image. The feature extraction method is not limited, nor is the quantity of channels of the image to be adjusted.

Optionally, the second target resolution can be the target resolution that needs to be adjusted for the image to be adjusted.

Second, in S202, Determine M pixel expansion directions based on the second target resolution and the resolution of the image to be adjusted.

This method imposes no restrictions the method for determining M, nor does it limit the method for determining the pixel expansion direction.

Optionally, M can be a positive integer and M≥1; wherein the product of (M+1) and the resolution of the image to be adjusted can be greater than or equal to the second target resolution.

Optionally, the pixel expansion direction can be determined based on the width-height ratio between the second target resolution and the resolution of the image to be adjusted.

For example, for an image to be adjusted having resolution of 4*4 (both width and height are 4) and a second target resolution with a value of 4*8 (width is 4 and height is 8), it can be determined that pixel expansion needs to be performed in the vertical direction to achieve image super-resolution, that is, to improve the image resolution. Therefore, the vertical direction can be determined as the pixel expansion direction.

In another example, for an image to be adjusted having resolution of 4*4 (both width and height are 4) and a second target resolution of 8*8 (width is 8 and height is 8), it can be determined that pixel expansion is required in three directions. Specifically, this can include vertical, horizontal, and diagonal directions.

Third, in S203, for the image to be adjusted, acquire M edge feature data in M pixel expansion directions. In S204, synthesize the image to be adjusted and the M edge feature data to obtain a target image with the second target resolution.

Since the extracted edge feature data is related to the subsequent synthesis method, S203 and S204 are explained together.

This method imposes no restrictions the specific method of extracting edge feature data.

Optionally, inter-pixel gradient feature data in the pixel extension direction can be extracted according to the pixel extension direction; or pixel value change feature data in the pixel extension direction can be extracted according to the pixel extension direction. This method imposes no restrictions the specific synthesis method.

Optionally, a pre-trained network or model can be configured to input the image to be adjusted and M edge feature data to obtain a target image having resolution equal to the second target resolution output by the network or model. Alternatively, the image to be adjusted can be concatenated on M edge feature data in separate channels, and the channels can be merged based on the concatenated results, followed by image composition to obtain a target image having resolution equal to the second target resolution.

For ease of understanding, an optional implementation example is provided below for illustrative purposes.

Optionally, for the image to be adjusted, M edge feature data in M pixel expansion directions can be acquired, which can include: for the image to be adjusted, M edge feature images can be extracted using M preset convolution kernels corresponding to M pixel expansion directions; the resolution of the edge feature images is the same as the resolution of the image to be adjusted.

Optionally, different pixel expansion directions can correspond to different preset convolution kernels; the preset convolution kernels can be configured to extract inter-pixel gradient feature data in the corresponding pixel expansion direction.

Specific examples of preset convolution kernels can be found below.

This embodiment imposes no restrictions the synthesis method.

Optionally, the M edge feature images and the image to be adjusted can be directly composited to obtain the target image.

Optionally, feature images can be extracted from the M edge feature images and the image to be adjusted, and then composited to obtain the target image.

Optionally, a pre-trained model or network can be configured to extract features from the input M edge feature images and the image to be adjusted to obtain the target image.

Optionally, synthesize the image to be adjusted and the M edge feature data to obtain a target image having resolution equal to the second target resolution, which may include: inputting the image to be adjusted and the M edge feature images into a pre-trained image composition network to obtain a target image having resolution equal to the second target resolution output by the image composition network; the target image has the same quantity of channels as the image to be adjusted.

This embodiment imposes no restrictions the specific structure of the image composition network.

Optionally, the image composition network may only include a convolution layer, or may include a convolution layer and an output layer for outputting the target image.

Optionally, the image composition network may include a feature extraction layer and a composition layer. Among them, the feature extraction layer can be configured to extract image features, and can specifically include one or more convolution layers, or can also include a Unet network structure.

Optionally, the feature extraction layer can be used for feature focusing, and can specifically be configured to perform feature focusing on the image to be adjusted and M edge feature images, so that image features of different branches can be learned, improving the display effect of image super-resolution.

Optionally, the composition layer can be configured to composite the images output by the feature extraction layer and output the target image having resolution that is the second target resolution.

Optionally, the composition layer can change the quantity of channels of the input and output images.

Optionally, the image composition network can be used for: for M edge feature images, perform channel concatenation with the image to be adjusted to obtain M concatenated results; for the M concatenated results and the image to be adjusted, use the feature extraction layer to extract features to obtain M+1 images to be composited the same resolution and channel number as the image to be adjusted; input the M+1 images to be composited into the composition layer to obtain a target image with the second target resolution and the same channel number as the image to be adjusted.

Of course, optionally, the image composition network can not perform channel concatenation, but can be directly used for M edge feature images and the image to be adjusted, respectively using the feature extraction layer to extract features, to obtain M+1 images to be composited the same resolution and quantity of channels as the image to be adjusted; inputting the M+1 images to be composited into the composition layer to obtain a target image with a second target resolution and the same quantity of channels as the image to be adjusted.

This embodiment imposes no restrictions the structure and function of the feature extraction layer and the composition layer.

Optionally, the feature extraction layer may include multiple different convolution layers, specifically include M+1 different convolution layers. Thus, for the M concatenated results and the image to be adjusted, different convolution layers in the feature extraction layer can be configured to extract features, respectively, to obtain M+1 images to be composited.

Optionally, the feature extraction layer may include multiple different feature focusing layers, and the resolution and quantity of channels of the input and output images of the feature focusing layers may be the same. The feature focusing layer may specifically include a Unet network. The feature extraction layer may specifically include M+1 different feature focusing layers. Thus, for the M concatenated results and the image to be adjusted, features can be extracted using different feature focusing layers in the feature extraction layer to obtain M+1 images to be composited.

Through different convolution layers and/or feature focusing layers, image features of different branches can be learned separately, thereby facilitating the improvement of the image composition network and the display effect.

Optionally, the composition layer can be configured to: perform the following operations on each pixel point in the image to be composited corresponding to the image to be adjusted to obtain the composition result: with the pixel point to be adjusted as the starting point, based on the M pixel expansion direction, expand to obtain a pixel matrix containing M+1 pixels, and integrate the other M pixels in the images to be composited that are in the same position as the target pixel to the expanded pixel matrix; based on the obtained composition result, through preset image processing, obtain a target image having resolution that is the second target resolution and the same quantity of channels as the image to be adjusted.

Optionally, the pixel matrix obtained by the extension may include the pixel as the starting point.

Optionally, since the product of (M+1) and the resolution of the image to be adjusted may be greater than or equal to the second target resolution, the resolution of the obtained composition result may be greater than or equal to the second target resolution.

This embodiment imposes no restrictions the method of image processing.

Optionally, when the resolution of the composition result is equal to the second target resolution, the composition result can be directly determined as the target image.

Optionally, when the resolution of the composition result is higher than the second target resolution, a target image having resolution equal to the second target resolution and the same quantity of channels as the image to be adjusted can be obtained by deleting or merging some pixels, or by subsampling the image, such as in the embodiment in method steps S101-S104 above.

In an optional embodiment, the embodiment included in the above method can be implemented using a single image super-resolution network.

The image super-resolution network can be configured to perform super-resolution on the image to be adjusted, thereby improving the resolution.

Optionally, the image to be adjusted and the second target resolution can be input to the image super-resolution network to acquire the target image output by the image super-resolution network.

Optionally, the image super-resolution network may include the image composition network in the above-mentioned embodiment. The image super-resolution network may determine M pixel expansion directions for the image to be adjusted, and then execute the method of the above-mentioned embodiment to obtain the target image.

For ease of understanding, the present invention also provides three application embodiments.

Application embodiment 1.

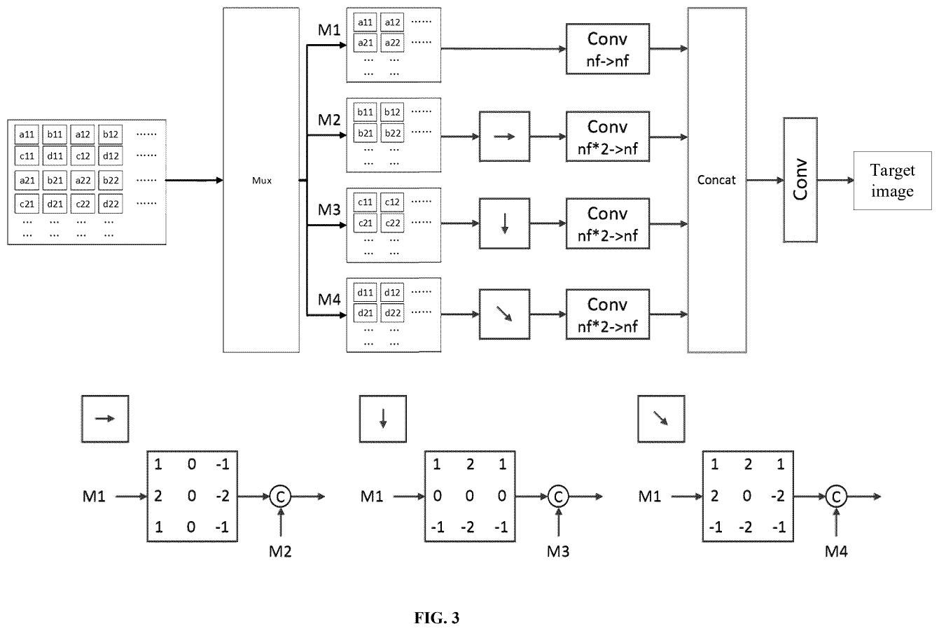

As shown in FIG. 3, FIG. 3 is a structural diagram of an image downsampling network according to an embodiment of the present invention. In which, the image downsampling network may include a splitting layer (mux layer), a direction operator layer, a convolution layer, and an output layer.

The image downsampling network in FIG. 3 can reduce the resolution of an image to be adjusted having resolution of 20*20 to 10*10.

For the mux layer, the mux layer decomposes a two-dimensional matrix according to the pixel arrangement rules shown in the FIG. into four small matrices whose length and width are half of the original matrix (for example, M1, M2, M3, and M4 in FIG. 3).

The image downsampling network can use the mux layer to partition the input image to be adjusted (with nf channels) into four 10×10 candidate images. Specifically, the image to be adjusted can be partitioned into 100 2×2 pixel matrices, such as a11, b11, c11, and d11.

Then, a pixel can be selected from a fixed position in each pixel matrix and composited to form a candidate image. For example, the pixels in the upper left corner of each 2*2 pixel matrix can be selected and composited to form a candidate image including pixels all, a12, . . . a21, a22, etc. (the candidate image a described below, which is M1 in FIG. 3).

For the direction operator layer, one of the candidate images can be selected as the starting image. In FIG. 3, candidate image a is selected as the starting image, so that the relative directions of the pixels at the same position between the candidate images in the pixel matrix to which they belong can be determined.

For example, the candidate images of pixels b11, b12, . . . b21, b22, etc. (hereinafter referred to as candidate image b, which is M2 in FIG. 3), b11 is on the right side of all.

Furthermore, the inter-pixel gradient feature data between pixels in the relative direction can be extracted from candidate image a (i.e., M1) using the preset convolution kernel corresponding to the relative direction.

For example, for a preset convolution kernel corresponding to the right direction, inter-pixel gradient feature data in the right direction can be extracted.

Of course, the preset convolution kernel examples in FIG. 3 are only used for illustrative purposes and do not limit the scope of this specification.

In the direction operator layer, for the same relative direction, the “inter-pixel gradient feature data between pixels in the direction of candidate image a” and “other candidate images in that direction” can be channel-concatenated for subsequent feature extraction using the convolution layer. The quantity of channels of the concatenated result is nf*2.

For example, for a directional operator in the right direction, the inter-pixel gradient feature data between pixels in the right direction of candidate image a (M1) and candidate image b can be channel-concatenated.

For the convolution layer, different convolution layers can be configured to extract features from the concatenated results output by the directional operator layer in candidate image a (M1) and the other three branches, respectively.

For candidate image a, features can be extracted directly using a convolution layer with a constant quantity of channels. Of course, features can also be omitted.

For the concatenated results in the other three branches, features can be extracted using a convolution layer that merges image channels, reducing the quantity of channels from nf*2 to nf.

Conv (nf*2->nf) in FIG. 3 represents that the quantity of channels input to this convolution layer is nf*2 and the quantity of channels output is nf. (nf can be 64, 48, 32, etc.).

For the output layer, the features extracted by the convolution layer in the four branches can first be channel concatenated, and then the concatenated results can be channel fused through the convolution layer, while the resolution can remain unchanged, thereby obtaining a target image having the first target resolution and the same quantity of channels as the image to be adjusted.

After the subsequent Concat channel concatenation, the four groups of features can be merged through a convolution layer, which has nf*4 input channels and nf output channels.

This network structure can be used as a downsampling operator in deep learning networks.

Application example 2.

As shown in FIG. 4, FIG. 4 is a schematic diagram of another image downsampling network structure according to an embodiment of the present invention. In which, the image downsampling network can include a splitting layer (mux layer), a downsampling max pooling layer (maxpooling layer), a convolution layer, and an inter-image max pooling layer (Gmaxpooling layer).

The image downsampling network in FIG. 4 can reduce the resolution of an image to be adjusted (with nf channels) having resolution of 20*20 to 10*10.

The mux layer can be referred to the explanation of the first application example above.

For the downsampling max pooling layer, it can be configured to determine the largest pixel value in each partitioned pixel matrix, thereby obtaining a 10*10 max pooling feature map.

For example, for the pixel matrix (a11, b11, c11, and d11), the largest pixel value can be determined and set as the pixel value in the max pooling feature map.

The max pooling layer can be configured to downsample the image I to be adjusted through max pooling to obtain the image. Specifically, the maximum values within a small area can be retained, and these maximum values can better represent the detailed texture information of the image.

For the convolution layer, the max pooling feature map can be channel-concatenated and convolved with four candidate images, respectively. Specifically, feature fusion can be performed through convolution to obtain four alternative images (i.e., F1-F4) with nf channels and resolution of 10*10.

After Mux, M1\M2\M3\M4 obtained can be concatenated on the max pooling feature map, and feature fusion can be performed through convolution. Here, the input channel of Conv is nf*2, and the output channel is nf.

For the max pooling layer between images, max pooling between images can be performed for F1-F4, that is, the maximum pixel value corresponding to the four pixel points at the same position between F1-F4 can be determined, thereby obtaining the target image with a final channel quantity of nf and resolution of 10*10.

The Gmaxpooling layer performs point-to-point selection of the maximum values from F1/F2/F3/F4 and outputs the result. Gmaxpooling (F1,F2,F3,F4)=MAX (F1,F2,F3,F4).

### Application of Example 3

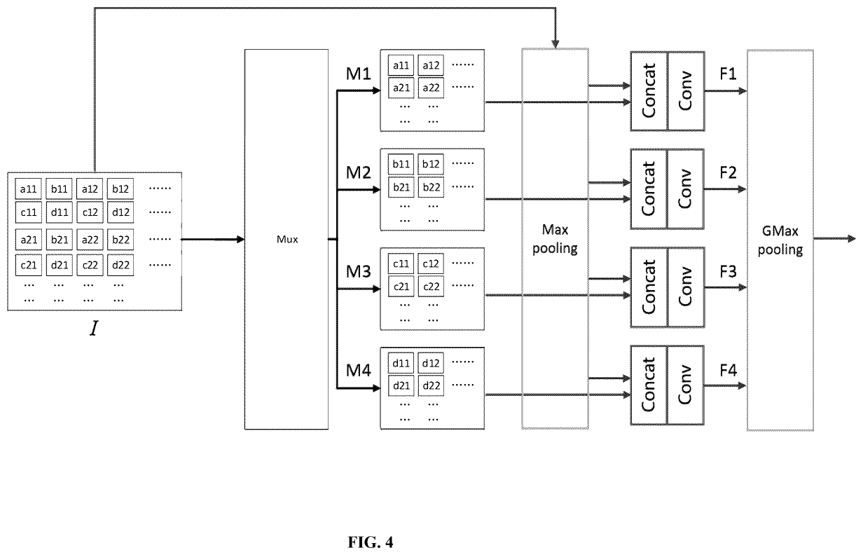

As shown in FIG. 5, FIG. 5 is a schematic diagram of an image super-resolution network according to an embodiment of the present invention.

Based on the idea of downsampling using the above directional operator, an image super-resolution network can be designed in the same way. The image super-resolution network can include a feature extraction layer, a directional operator layer, a feature focusing layer, and a composition layer (DeMux layer).

The image super-resolution network in FIG. 5 can increase the resolution of an image to be adjusted (having resolution of 10*10 and nf channels) to 20*20.

For the feature extraction layer, a convolution layer can be configured to extract features from image I. The extracted feature map F can have the same resolution as image I, and the quantity of channels in feature map F can be higher than that in image I.

It should be noted that image I can be regarded as the image to be adjusted, and feature map F can also be regarded as the image to be adjusted.

The purpose of the feature extraction layer in the network in FIG. 5 is to convert image data into feature information. The simplest method is to use a 3×3 convolution layer, or 2/3/n convolution layers can be used continuously for feature extraction. This embodiment does not impose specific network structure restrictions.

For the direction operator layer, three pixel expansion directions can be determined, which are to the right, down, and diagonally down to the right.

First, the direction operators of each branch are explained. For feature map F, the pre-set convolution kernel can be configured to extract the inter-pixel gradient feature data in each pixel expansion direction.

After that, the extracted inter-pixel gradient feature data can be channel-concatenated with feature map F.

Among them, the inter-pixel gradient feature data extracted using the preset convolution kernel can be a gradient feature map. The resolution of the gradient feature map can be the same as that of feature map F.

For the feature focusing layer, this embodiment imposes no restrictions the specific structure. Optionally, a convolution layer can be configured to extract features, or a Unet structure can be used.

The feature focusing layer in FIG. 5 extracts the feature information of the image on each branch. For example, a typical Unet structure can be used. Similarly, Unet is only an example here. In theory, networks commonly used in super-resolution can be used as feature focusing layers here.

Each feature focusing layer can extract features from the concatenated results output by each branch to obtain four images to be composited. The resolution of the images to be composited is 10*10, and the quantity of channels is nf.

It should be noted that the feature map F itself can use the feature focusing layer, specifically by extracting features through Unet, while the quantity of channels and resolution of the input and output images can remain unchanged.

For the other three branches that use directional operators, channel concatenation can be configured to obtain nf*2 concatenated results, so that the feature focusing layer can be configured to extract feature maps with unchanged resolution and a reduced quantity of channels to nf. Optionally, in the other three branches that use directional operators, the feature focusing layer can be set before Unet with a Conv (nf*2->nf).

For the composition layer, the four images to be composited can be composited.

In the previous application example, the Mux layer can split the pixels of the image into four small parts. According to the position of the pixels, it can be found that each small part has certain directional information, so the direction operator can be configured to extract the image data more effectively.

Similarly, DeMux also merges the four small images into one large image according to the same arrangement rules as Mux. Therefore, when designing a super-resolution network, the direction operator can be configured to partition it into four branches for feature extraction, and finally, it is super-resolved into a large image through DeMux.

The Demux layer composites two-dimensional matrices, merging four small matrices having the same size into a larger matrix, where the width and height of the larger matrix are twice those of the small matrices.

For example, the pixels (a11, b11, c11, and d11) at the same position in the four images to be composited can be composited into the same pixel matrix, thereby obtaining a target image having resolution of 20*20.

The composition layer can change the quantity of channels of the input and output images, thereby obtaining a target image with nf channels based on the images to be composited nf channels.

Corresponding to the above method embodiments, the present invention also provides corresponding device embodiments.

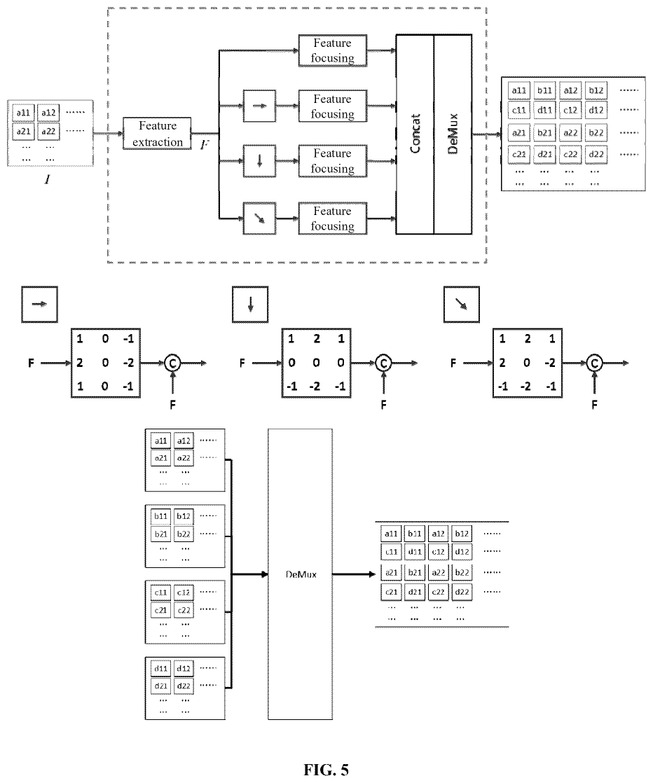

As shown in FIG. 6, FIG. 6 is a structural diagram of an image resolution adjustment device according to an embodiment of the present invention.

The device may include the following units: a first acquisition unit 301 for acquiring the image to be adjusted and the first target resolution; the resolution of the image to be adjusted is higher than the first target resolution; a partitioning unit 302 for partitioning the image to be adjusted into N candidate images having the first target resolution as the resolution; wherein the data of each pixel in the image to be adjusted is included in any one of the candidate images; N is a positive integer and N>1; a first feature unit 303, for extracting edge feature data from the candidate images obtained by partitioning; a first synthesizing unit 304, for synthesizing the N candidate images obtained by partitioning and the extracted edge feature data to obtain a target image having resolution equal to the first target resolution.

Optionally, the partitioning unit 302 is configured to: partition the image to be adjusted into a quantity of pixel matrices having the same size based on the first target resolution; the pixel matrix includes N pixels, and in the image to be adjusted, the quantity of pixel matrices in a single row by partitioning in a horizontal direction is the same as the quantity of pixels in a single row of the first target resolution, the quantity of single-row pixel matrices partitioned in the vertical direction is the same as the quantity of pixels in a single row of the first target resolution; and extract N candidate images having resolution equal to the first target resolution based on the partitioned pixel matrices.

Optionally, pixels at the same position in different candidate images belong to the same pixel matrix; different pixels in any candidate image are located at the same position in the pixel matrix to which they belong.

Optionally, the first feature unit 303 is configured to: determine any candidate image as the starting image; for the starting image, use the N−1 preset convolution kernels corresponding to the N−1 other candidate images to extract the N−1 edge feature images corresponding to the N−1 other candidate images; the resolution of the edge feature images is the first target resolution; wherein different candidate images correspond to different preset convolution kernels; the preset convolution kernels are configured to extract inter-pixel gradient feature data in a preset direction; the preset direction is a relative direction between two different pixels at the same position in a corresponding candidate image and the starting image and belong to the same pixel matrix.

Optionally, the first synthesizing unit 304 is configured to: input the N candidate images obtained by partitioning and the N−1 edge feature images extracted into a pre-trained image channel fusing network to obtain a target image having resolution equal to the first target resolution output by the image channel fusing network. Optionally, the target image can have the same quantity of channels as the image to be adjusted.

Optionally, the image channel fusing network is configured to: For each of the N−1 other candidate images, perform channel concatenation with a corresponding edge feature image to obtain N−1 concatenated images; for the N−1 concatenated images and the starting image, use the feature extraction layer to extract features to obtain N convolutional feature images; perform channel concatenation on the N convolutional feature images, and then use the channel fusing layer to extract features to obtain a target image having resolution equal to the first target resolution and the same quantity of channels as the image to be adjusted.

Optionally, the first feature unit 303 is configured to: for each identical position among the N candidate images obtained by partitioning, perform the following operations to obtain the max pooling feature map having the first target resolution, and determine the max pooling feature map as the extracted edge feature data: among the N candidate images, obtain the pixel value corresponding to the N pixels at the target position with the largest pixel value, determine the pixel value corresponding to the pixel at the position targeted in the max pooling feature map.

Optionally, the first synthesizing unit 304 is configured to: input the N candidate images obtained by partitioning and the max pooling feature map into a pre-trained image channel fusing network to obtain a target image having resolution equal to the first target resolution and output by the image channel fusing network. Optionally, the target image can have the same quantity of channels as the image to be adjusted.

Optionally, the image channel fusing network is configured to: perform channel concatenation with the max pooling feature map for the N candidate images to obtain N concatenated results; for the N concatenated results, use the feature extraction layer to extract features to obtain N alternative images having the first target resolution and the same quantity of channels as the image to be adjusted; input the N alternative images into the max pooling layer to obtain a target image having resolution equal to the first target resolution and the same quantity of channels as the image to be adjusted.

Optionally, the max pooling layer is used for: for each identical position among the N alternative images, performing the following operations to obtain a target image having resolution equal to the first target resolution and the same quantity of channels as the image to be adjusted: among the N alternative images, determining the pixel value corresponding to the N pixel points at the target position as the pixel value corresponding to the pixel point at the target position in the target image.

For a specific explanation, refer to the above method embodiment.

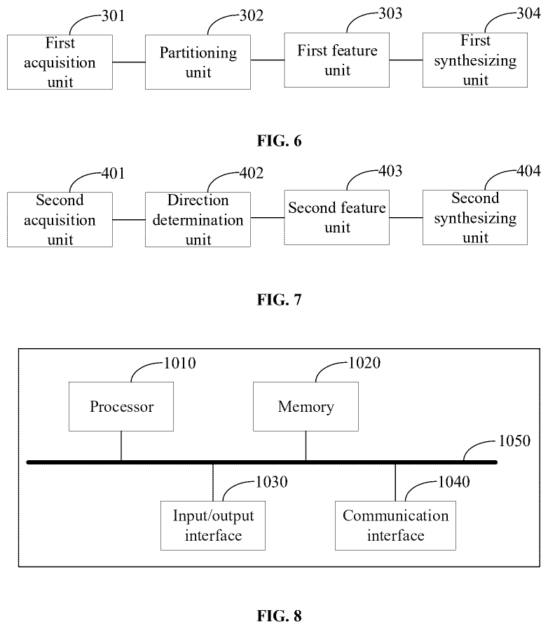

As shown in FIG. 7, FIG. 7 is a structural diagram of another image resolution adjustment device according to an embodiment of the present invention.

The device may include the following units.

A second acquisition unit 401 is configured to acquire the image to be adjusted and the second target resolution, resolution of the image to be adjusted being lower than the second target resolution; a direction determination unit 402 is configured to determine M pixel expansion directions based on the second target resolution and the resolution of the image to be adjusted; M is a positive integer and M≥1; wherein the product of (M+1) and the resolution of the image to be adjusted is greater than or equal to the second target resolution; a second feature unit 403, for acquiring M edge feature data in M pixel expansion directions for the image to be adjusted; and a second synthesizing unit 404, for synthesizing the image to be adjusted and the M edge feature data to obtain a target image having resolution equal to the second target resolution.

Optionally, the second feature unit 403 is configured to: for the image to be adjusted, extract M edge feature images using M preset convolution kernels corresponding to the M pixel expansion directions; the resolution of the edge feature images is the same as the resolution of the image to be adjusted; wherein different pixel expansion directions correspond to different preset convolution kernels; the preset convolution kernels are configured to extract inter-pixel gradient feature data in the corresponding pixel expansion directions.

Optionally, the second synthesizing unit 404 is configured to: input the image to be adjusted and the M edge feature images into the pre-trained image composition network to obtain a target image having resolution that is the second target resolution output by the image composition network; the target image has the same quantity of channels as the image to be adjusted.

Optionally, the image composition network is configured to: for the M edge feature images, perform channel concatenation with the image to be adjusted, obtaining M concatenated results; for the M concatenated results and the image to be adjusted, respectively using the feature extraction layer to extract features, obtaining M+1 images to be composited the same resolution and quantity of channels as the image to be adjusted; inputting the M+1 images to be composited into the composition layer, obtaining a target image having resolution that is the second target resolution and the same quantity of channels as the image to be adjusted.

Optionally, the composition layer is configured to: perform the following operations on each pixel in the image to be composited corresponding to the image to be adjusted to obtain the composition result: starting from the pixel to be adjusted, based on the M pixels, expand in the expansion direction to obtain a pixel matrix containing M+1 pixels, and integrate the other M pixels in the other M images to be composited that are in the same position as the pixel to be targeted to the expanded pixel matrix; based on the obtained composition result, perform predetermined image processing to obtain a target image having resolution equal to the second target resolution and the same quantity of channels as the image to be adjusted. For a specific explanation, see the above method embodiment.

The present invention also provides a computer apparatus that at least includes a memory, a processor, and a computer program stored on the memory and executable on the processor, wherein the processor performs the above method embodiment when executing the program.

The present invention also provides an electronic device including: at least one processor; and a memory connected in communication with the at least one processor; wherein the memory stores instructions executable by the one processor, and the instructions are executed by the at least one processor to enable the at least one processor to perform any of the above-mentioned method embodiments.

FIG. 8 is a schematic diagram of a computer apparatus hardware configuration for implementing the method according to an embodiment of the present invention, which may include: a processor 1010, a memory 1020, an input/output interface 1030, a communication interface 1040, and a bus 1050. The processor 1010, the memory 1020, the input/output interface 1030, and the communication interface 1040 are connected to each other within the apparatus for communication via the bus 1050.

Processor 1010 may be implemented using a general-purpose CPU (Central Processing Unit), a microprocessor, an application-specific integrated circuit (ASIC), or one or more integrated circuits, and is configured to execute relevant programs to implement the technical solutions provided by the embodiments of the present invention.

The memory 1020 can be implemented in the form of ROM (Read Only Memory), RAM (Random Access Memory), static storage apparatus, dynamic storage apparatus, etc. Memory 1020 can store an operating system and other application programs. When implementing the technical solutions provided by the embodiments of the present invention through software or firmware, the relevant program code is stored in memory 1020 and called and executed by processor 1010.

The input/output interface 1030 is configured to connect the input/output module to enable data input and output. The input/output module can be configured as a component in the apparatus (not shown in the figure) or can be connected to the apparatus to provide the corresponding function. The input device can include a keyboard, mouse, touch screen, microphone, various sensors, etc., and the output device can include a display, speaker, vibrator, indicator light, etc.

The communication interface 1040 is configured to connect communication modules (not shown in the figure) to enable communication and interaction between this apparatus and other apparatuses. The communication modules can communicate via wired means (e.g., USB, network cable, etc.) or wireless means (e.g., mobile network, WIFI, Bluetooth, etc.).

Bus 1050 includes a channel for transmitting data between various components of the apparatus (e.g., processor 1010, memory 1020, input/output interface 1030, and communication interface 1040).

It should be noted that although the above-mentioned apparatus only shows the processor 1010, memory 1020, input/output interface 1030, communication interface 1040, and bus 1050, in the specific implementation, the apparatus may also include other components necessary for normal operation. In addition, it will be understood by those skilled in the art that the above-mentioned apparatus may also include only the components necessary to implement the embodiments of the present invention, without necessarily including all the components shown in the figure.

The present invention also provides a computer-readable storage medium on which is stored a computer program, which, when executed by a processor, implements any of the above-mentioned method embodiments.

The present invention also provides a computer-readable storage medium storing a computer program, which, when executed by a processor, implements any of the above-described method embodiments.

Computer-readable media include permanent and non-permanent, removable and non-removable media, and may be implemented by any method or technology for storing data. The data may be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic tape, disk storage or other magnetic storage apparatus, or any other non-transmissive medium that can be configured to store information that can be accessed by a computing device. As defined herein, computer-readable media does not include transitory media, such as modulated data signals and carrier waves.

From the above description of the embodiments, those skilled in the art can clearly understand that the embodiments of the present invention can be realized by means of software and the necessary general-purpose hardware platform. Based on this understanding, the technical solution of the embodiments of the present invention can essentially be embodied in the form of software products, which can be stored in storage media such as ROM/RAM, magnetic disks, optical disks, etc., and include a quantity of instructions for causing a computer device (which can be a personal computer, server, or network device, etc.) to perform the methods described in the embodiments or certain parts of the embodiments of the present invention.

The systems, devices, modules, or units described in the above embodiments can be specifically implemented by computer chips or physical entities, or by products with certain functions. A typical implementation device is a computer, and the specific form of the computer can be a personal computer, laptop, cellular phone, camera phone, smart phone, personal digital assistant, media player, navigation device, email device, game console, tablet computer, wearable device, or any composition of these devices.

Each embodiment in this specification is described in a progressive manner, and the same or similar parts between each embodiment can be referred to each other. Each embodiment focuses on the differences from other embodiments. In particular, for device embodiments, since they are basically similar to method embodiments, the description is relatively simple, and the relevant parts can be referred to the description of the method embodiments. The device embodiments described above are only illustrative, and the modules described as separate components may or may not be physically separate. When implementing the embodiments of the present invention, the functions of each module may be implemented in one or more pieces of software and/or hardware. It is also possible to select some or all of the modules to achieve the purpose of the embodiment according to actual needs. Those skilled in the art can understand and implement the embodiments without creative labor.

The above is only a specific embodiment of the invention. It should be noted that for ordinary technicians in the field, without departing from the principle of the invention, a quantity of improvements and modifications can be made, and these improvements and modifications should also be considered as protected by the invention.

In the present invention, the terms “first” and “second” are used for descriptive purposes only and should not be understood as indicating or implying relative importance. The term “multiple” refers to two or more, unless otherwise explicitly specified.

Those skilled in the art will readily conceive other embodiments of the present invention upon consideration of the disclosure herein. The present invention is intended to encompass any variations, uses, or adaptive changes of the present invention that follow the general principles of the present invention and include common knowledge or conventional techniques in the technical field that are not disclosed herein. The specification and examples are merely illustrative, and the true scope and spirit of the present invention are defined by the appended claims.

It should be understood that the present invention is not limited to the precise structure described above and shown in the accompanying drawings, and various modifications and changes may be made without departing from its scope. The scope of the present invention is limited only by the appended claims.

1. A method for image resolution adjustment, comprising:
acquiring an image to be adjusted and a first target resolution, resolution of the image to be adjusted being higher than the first target resolution;
partitioning the image to be adjusted into N candidate images having resolution equal to the first target resolution, wherein data of each pixel in the image to be adjusted is included in any of the candidate images, N is a positive integer greater than 1;
extracting edge feature data from the candidate images; and
synthesizing the N candidate images obtained by partitioning and the edge feature data to obtain a target image having resolution equal to the first target resolution.

2. The method according to claim 1, wherein partitioning the image to be adjusted into N candidate images having resolution equal to the first target resolution comprises:
partitioning the image to be adjusted into a quantity of pixel matrices having the same size based on the first target resolution, wherein each of the pixel matrices comprises N pixels;
wherein in the image to be adjusted, the quantity of pixel matrices in a single row by partitioning in a horizontal direction is the same as the quantity of pixels in a single row of the first target resolution, and the quantity of pixel matrices in a single column by partitioning in a vertical direction is the same as the quantity of pixels in a single column of the first target resolution;
and, extracting the N candidate images having resolution equal to the first target resolution based on the partitioned pixel matrices.

3. The method according to claim 2, wherein pixels at the same position in different candidate images belong to the same pixel matrix, and different pixels in any candidate image are located at the same position in pixel matrices to which the different pixel points belong.

4. The method according to claim 3, wherein extracting the edge feature data from the candidate images comprises:
determining any one of the candidate images as a starting image; and
for the starting image, extracting N−1 edge feature images corresponding to N−1 other candidate images using N−1 preset convolution kernels corresponding to the N−1 other candidate images, wherein resolution of the edge feature images is equal to the first target resolution;
wherein different candidate images correspond to different preset convolution kernels, the preset convolution kernels are configured to extract inter-pixel gradient feature data in a preset direction, the preset direction is a relative direction between two different pixels that are at the same position in a corresponding candidate image and the starting image and belong to the same pixel matrix.

5. The method according to claim 4, wherein synthesizing the N candidate images and the edge feature data to obtain a target image having resolution equal to the first target resolution comprises:
inputting the N candidate images and the N−1 edge feature images into a pre-trained image channel fusing network to obtain the target image having resolution equal to the first target resolution that is output by the image channel fusing network.

6. The method according to claim 5, wherein the image channel fusing network is configured to:
for each of the N−1 other candidate images, perform channel concatenation with a corresponding edge feature image to obtain N−1 concatenated images;
for the N−1 concatenated images and the starting image, extract features using a feature extraction layer to obtain N convolutional feature images; and
perform channel concatenation on the N convolutional feature images, and extract features using a channel fusing layer to obtain a target image having resolution equal to the first target resolution and having the same quantity of channels as the image to be adjusted.

7. The method according to claim 2, wherein extracting the edge feature data from the candidate images comprises:
for each identical position among the N candidate images, performing following operations to obtain a max pooling feature map having the first target resolution, and determining the max pooling feature map as the edge feature data:
for each target position, determining a maximum pixel value among pixel values of N corresponding pixels at the target position in the N candidate images as a pixel value of a pixel at the target position in the max pooling feature map.

8. The method according to claim 7, wherein synthesizing the N candidate images and the edge feature data to obtain a target image having resolution equal to the first target resolution comprises:
inputting the N candidate images and the max pooling feature map into a pre-trained image channel fusing network to obtain the target image having resolution equal to the first target resolution that is output by the image channel fusing network.

9. The method according to claim 8, wherein the image channel fusing network is configured to:
for each of the N candidate images, perform channel concatenation with the max pooling feature map to obtain N concatenated results;
for each of the N concatenated results, extract features using the feature extraction layer to obtain N alternative images having resolution equal to the first target resolution and having a same quantity of channels as the image to be adjusted; and
input the N alternative images into a max pooling layer to obtain the target image having resolution equal to the first target resolution and having the same quantity of channels as the image to be adjusted.

10. A method for image resolution adjustment, comprising:
acquiring an image to be adjusted and a second target resolution, resolution of the image to be adjusted being lower than the second target resolution;
determining M pixel expansion directions based on the second target resolution and the resolution of the image to be adjusted, wherein M is a positive integer and M≥1, and a product of (M+1) and the resolution of the image to be adjusted is higher than or equal to the second target resolution;
acquiring M edge feature data in the M pixel expansion directions for the image to be adjusted, respectively; and
synthesizing the image to be adjusted and the M edge feature data to obtain a target image having resolution equal to the second target resolution.

11. The method according to claim 10, wherein acquiring the M edge feature data in the M pixel expansion directions for the image to be adjusted, respectively, comprises:
for the image to be adjusted, extracting M edge feature images using M preset convolution kernels corresponding to the M pixel expansion directions, wherein resolution of the edge feature images is the same as the resolution of the image to be adjusted;
wherein different pixel expansion directions correspond to different preset convolution kernels, and each of the preset convolution kernels is configured to extract inter-pixel gradient feature data in a corresponding pixel expansion direction.

12. The method according to claim 11, wherein synthesizing the image to be adjusted and the M edge feature data to obtain a target image having resolution equal to the second target resolution comprises:
inputting the image to be adjusted and the M edge feature images into a pre-trained image composition network to obtain the target image having resolution equal to the second target resolution that is output by the image composition network, wherein the target image has a same quantity of channels as the image to be adjusted.

13. The method according to claim 12, wherein the image composition network is configured to:
for the M edge feature images, perform channel concatenation with the image to be adjusted to obtain M concatenated results;
for the M concatenated results and the image to be adjusted, extract features using a feature extraction layer to obtain M+1 images to be composited and having the same resolution and quantity of channels as the image to be adjusted; and
input the M+1 images to be composited into a composition layer to obtain the target image having resolution equal to the second target resolution and having the same quantity of channels as the image to be adjusted.

14. The method according to claim 13, wherein the composition layer is configured to:
perform following operations on each pixel in the image to be composited that corresponds to the image to be adjusted, to obtain a composition result:
starting from a target pixel, generating, by expanding along M pixel expansion directions, a pixel matrix having M+1 pixels, and integrating pixels at the same position as the target pixel in other M images to be composited into the pixel matrix obtained by expanding; and
based on the composition result obtained, performing a predetermined image processing to obtain the target image having resolution equal to the second target resolution and having the same quantity of channels as the image to be adjusted.

15. An image resolution adjustment device, comprising:
a first acquisition unit configured for acquiring an image to be adjusted and a first target resolution, resolution of the image to be adjusted being higher than the first target resolution;
a partitioning unit configured for partitioning the image to be adjusted into N candidate images having resolution equal to the first target resolution, wherein data of each pixel in the image to be adjusted is included in any of the candidate images, N is a positive integer greater than 1;
a first feature unit configured for extracting edge feature data from the candidate images; and
a first synthesizing unit configured for synthesizing the N candidate images and the edge feature data to obtain a target image having resolution equal to the first target resolution.

16. An image resolution adjustment device used to implement the method according to claim 10, comprising:
a second acquisition unit configured for acquiring an image to be adjusted and a second target resolution, resolution of the image to be adjusted being lower than the second target resolution;
a direction determination unit configured for determining M pixel expansion directions based on the second target resolution and the resolution of the image to be adjusted, wherein M is a positive integer and M≥1, and a product of (M+1) and the resolution of the image to be adjusted is higher than or equal to the second target resolution;
a second feature unit configured for acquiring M edge feature data in the M pixel expansion directions for the image to be adjusted, respectively; and
a second synthesizing unit configured for synthesizing the image to be adjusted and the M edge feature data to obtain a target image having resolution equal to the second target resolution.

17. An electronic apparatus, comprising at least one processor and a memory connected in communication with the at least one processor; wherein the memory stores instructions executable by the at least one processor, and the instructions are executed by the at least one processor to enable the at least one processor to perform the method according to claim 1.

18. A computer-readable storage medium storing a computer program, wherein the computer program, when executed by a processor, implements the method according to claim 1.

19. The device according to claim 15, wherein the partitioning unit is configured for:
partitioning the image to be adjusted into a quantity of pixel matrices having the same size based on the first target resolution, wherein each of the pixel matrices comprises N pixels;
wherein in the image to be adjusted, the quantity of pixel matrices in a single row by partitioning in a horizontal direction is the same as the quantity of pixels in a single row of the first target resolution, and the quantity of pixel matrices in a single column by partitioning in a vertical direction is the same as the quantity of pixels in a single column of the first target resolution;
and, extracting the N candidate images having resolution equal to the first target resolution based on the partitioned pixel matrices.

20. The device according to claim 19, wherein the first feature unit configured for:
for each identical position among the N candidate images, performing following operations to obtain a max pooling feature map having the first target resolution, and determining the max pooling feature map as the edge feature data:
for each target position, determining a maximum pixel value among pixel values of N corresponding pixels at the target position in the N candidate images as a pixel value of a pixel at the target position in the max pooling feature map.
